(19) United States
(12) Patent Application Publication
(10) Pub. No.: US 2023/0149252 A1
(43) Pub. Date: May 18, 2023

(54) THERAPEUTIC BOTTLE

(71) Applicant: Percy Walker, Clinton, MS (US)

(72) Inventor: Percy Walker, Clinton, MS (US)

(21) Appl. No.: 17/979,143

(22) Filed: Nov. 2, 2022

Related U.S. Application Data
(60) Provisional application No. 63/279,135, filed on Nov. 14, 2021.

(51) Int. Cl. A61H 15/00

(52) U.S. Cl. CPC A61H 15/0092; A61H 2015/0014

(57) ABSTRACT

A therapeutic bottle may include a cylindrical holder and a cylindrical vacuum seal vessel that is retained in the cylindrical holder. The bottle may include a stress-releasing foam structure that attaches around a top portion of the cylindrical holder; and a set of massage rollers attached below the stress-releasing foam structure on a side of the cylindrical holder. The bottle may also include a hand grip in a wave pattern shape that permanently sits below the stress-relating foam structure on a side of the cylindrical holder.

### CROSS-REFERENCE TO RELATED APPLICATIONS

This application claims priority to provisional application App. No. 63/279,135 filed Nov. 14, 2021, the contents are incorporated by references herein.

### FIELD

The present disclosure relates to a drinking bottle, in particular to a therapeutic bottle.

### BACKGROUND

People carry a drinking bottle around throughout their daily life. In the drinking bottles, people will carry water, tea, coffee, and various other drinks. Having a portable drinking bottle is convenient for most people, especially those who are on the go. For instance, someone who is going to work, class, and then the gym would use a portable drinking bottle to keep hydrated throughout the day. Additionally, people may have a hard time sitting still and some have pain in their hands due to various reasons.

### SUMMARY

In light of the foregoing background, the following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

One of more aspects of the present disclosure pertain to a therapeutic bottle including a cylindrical holder and a cylindrical vacuum seal vessel that is retained in the cylindrical holder. The bottle may include a stress-releasing foam structure that attaches around a top portion of the cylindrical holder; and a set of massage rollers attached below the stress-releasing foam structure on a side of the cylindrical holder. The bottle may also include a hand grip in an undulating pattern shape that permanently sits below the stress-relating foam structure on a side of the cylindrical holder.

An aspect of the present disclosure relates to a therapeutic bottle including a hollow vacuum seal vessel in the shape of a cylinder. The bottle may further include a cylindrical holder and a stress-releasing foam material that attaches around a top portion of the cylindrical holder. The bottle may further include and a set of round plastic massage rollers formed into a rectangular shape attached below the stress-releasing foam material to a side of the cylindrical holder.

Another aspect of the present disclosure relates to a therapeutic bottle including a cylindrical holder and a cylindrical vacuum seal vessel that is retained in the cylindrical holder. The bottle may include a set of massage rollers attached below the stress-relating foam structure on a side of the cylindrical holder.

Another aspect of the present disclosure relates to a therapeutic bottle including a cylindrical holder and a cylindrical vacuum seal vessel that is retained in the cylindrical holder. The bottle may include a hand grip in a undulating pattern shape that sits below the stress-relating foam structure on a side of the cylindrical holder.

Yet another aspect of the present disclosure relates to a therapeutic bottle including a cylindrical holder and a cylindrical vacuum seal vessel that is retained in the cylindrical holder. The bottle may include a hard-plastic vacuum sealed lid with an openable tab that screws into an apparatus that connects the vacuum sealed lid to the vacuum sealed vessel.

In yet another aspect of the present disclosure, a therapeutic bottle provides different tools to help with carpel tunnel, stress, and blood flow, and hand injury. For an example the act of repeatedly squeezing the foam structures at the top of the therapeutic bottle releases tension and helps to relieve stress. The benefits of the foam structures of the present disclosure may also include boosting blood circulation and helping with the treatment of carpal-tunnel syndrome and its use as a tool for meditation. Also, the foam structures can help with rehab after an injury.

In yet another aspect of the present disclosure, a therapeutic bottle also has rollers on the back located at the bottom thereof. The rollers help to alleviate muscle pains and aches. Also, the rollers provide a massage technique for a user's hands, and arms to provide a myofascial release. The rollers are also detachable from the therapeutic bottle for cleaning and the other uses.

These and other features, and characteristics of present technology, as well as the methods of operation and functions of the related elements of structure and the combination of parts and economics of manufacture, will become more apparent upon consideration of the following description and the appended claims with reference to the accompanying drawing, all of which form a part of this specification, wherein like reference numerals designate corresponding parts in various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural references unless the context clearly dictates otherwise.

### BRIEF DESCRIPTION OF THE DRAWINGS

FIG. 1 is a top plan view of the therapeutic bottle showing the vacuum sealed lid that is comprised of an openable tab that is pivotally fixated on the top lid according to the teachings of the present disclosure.

FIG. 2 is a bottom plan view of the therapeutic bottle showing the part of the bottle that would sit on the table according to the teachings of the present disclosure.

FIG. 3 is a front elevational view of the therapeutic bottle showing the wave shaped hand grip and the two stress-releasing foam material structures according to the teachings of the present disclosure.

FIG. 4 is a side elevational view of the therapeutic bottle showing the round plastic massage rollers, stress-releasing foam material structure, and the wave shaped hand grip according to the teachings of the present disclosure.

FIG. 5 is a slightly elevated view of the therapeutic bottle showing the vacuum sealed lid, the stress-releasing foam material structures, the wave shaped hand grip, and a small part of the plastic massage rollers according to the teachings of the present disclosure.

FIG. 6 is an exploded assembly view of the therapeutic bottle, showing components of the bottle and how they fit together; this view shoes the a hollow vacuum seal vessel in the shape of a cylinder, the separate cylindrical holder, the stress-releasing foam material that attaches around a top portion, preferably, the top half of the cylindrical holder, and the set of round plastic massage rollers formed into a rectangular shape that attaches on a lower part of side of the cylindrical holder according to the teachings of the present disclosure.

FIG. 7 is a back elevational view of the therapeutic bottle showing the plastic massage rollers and the two stress-releasing foam material structures according to the teaching of the present disclosure.

### DETAILED DESCRIPTION

The accompanying drawings, which form a part hereof, show examples of the disclosure.

It is to be understood that the examples shown in the drawings and/or discussed herein are non-exclusive and that there are other examples of how the disclosure may be practiced.

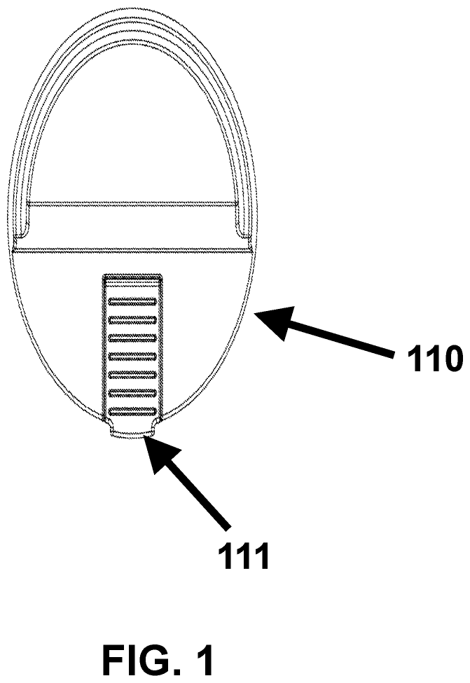

FIGS. 1 through 7 illustrate aspects of a therapeutic bottle 500 that may include a hollow vacuum seal vessel 100 in the shape of a cylinder, the separate cylindrical holder 200, a stress-releasing foam material assembly 300 that attaches around the top half of the cylindrical holder, and a set of round massage rollers 400 formed into a generally rectangular shape that attaches on a bottom portion of a side of the cylindrical holder 200. The vacuum seal vessel 100 slides into the cylindrical holder 200, and the stress-releasing foam material assembly 300 and the massage rollers 400 fit in their respective sections on cylindrical holder 200.

Referring to FIG. 1, a top view depicts a hard-plastic lid 110. This lid 110 further comprises of an openable tab that is fixated on the top lid 111 by pivot system to allow fluid inside to exit the bottle 500.

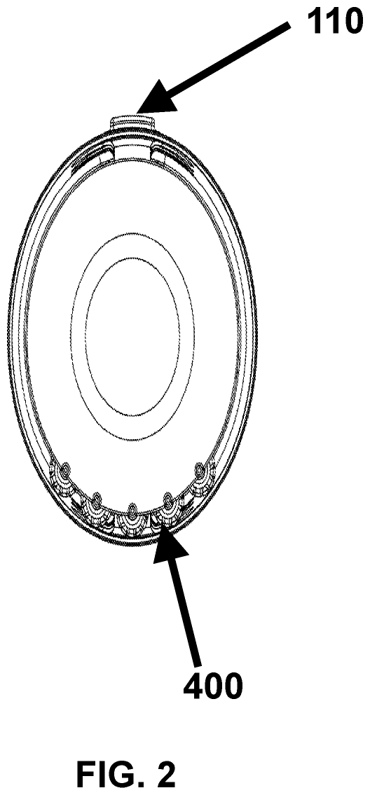

Referring to FIG. 2, a bottom view depicts a partial view of the hard-plastic massage rollers 400. A small portion of the tab 111 that is a part of the hard-plastic vacuum seal lid 110 is shown peaking at the top of the view. This view also shows a partial view of the foam material structures 310 and 320 that attaches around the top half of the cylindrical holder 200.

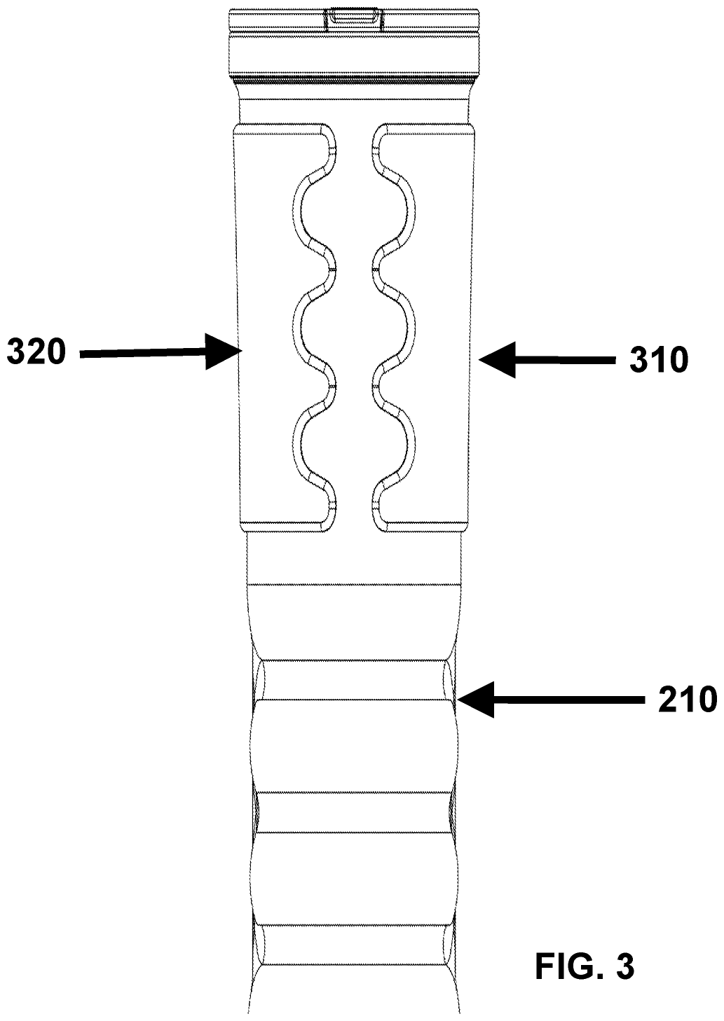

Referring to FIG. 3, a side view depicts the foam material structure 310 and 320 that attaches around the top portion of the cylindrical holder 200. In one implementation, the foam material structure 310 and 320 are separate structures that do not interconnect and attaches into two compartments around the top half of the cylindrical holder 200, thus leaving small spaces between them on either side of the cylindrical holder. Further the distal ends of the stress-releasing foam structures 310 and 320 are conformed in a wave like pattern. The wave pattern construction enables improved finger and palm massages of a hand of a user with repeated squeezing of foam material sections 310 and 320.

Below the stress-releasing foam structures 310 and 320 sits the hand grip that is shaped in an undulating pattern and includes three gripping divots 210. Above the stress-releasing foam structures 310 and 320 sits the hard-plastic lid 110 at the top of the bottle 500. In operation, the user can repeatedly squeeze the foam structure 310, 320 at the top of the bottle 500 to release tension and help to relieve stress. One or more of the benefits of foam structures 310, 320 also include boosting blood circulation and helping with the treatment of carpal-tunnel syndrome and its used as a tool for meditation.

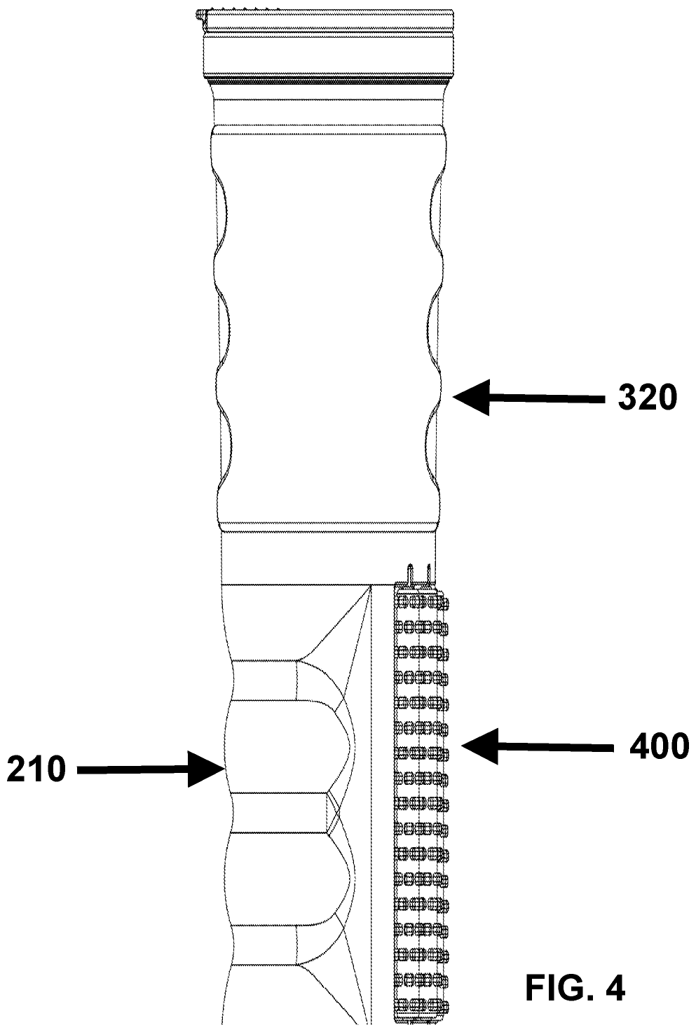

Referring to FIG. 4, this view shows the hard-plastic lid 110 at the top of the bottle 500. It also shows a partial view of hand grip that is shaped in an undulating pattern and includes three divots 210. A partial view of the hard plastic massage rollers 400 can also be seen. Lastly, there is a partial view of one of the stress-releasing foam material structure 310 that attaches to the top half of the cylindrical holder 200.

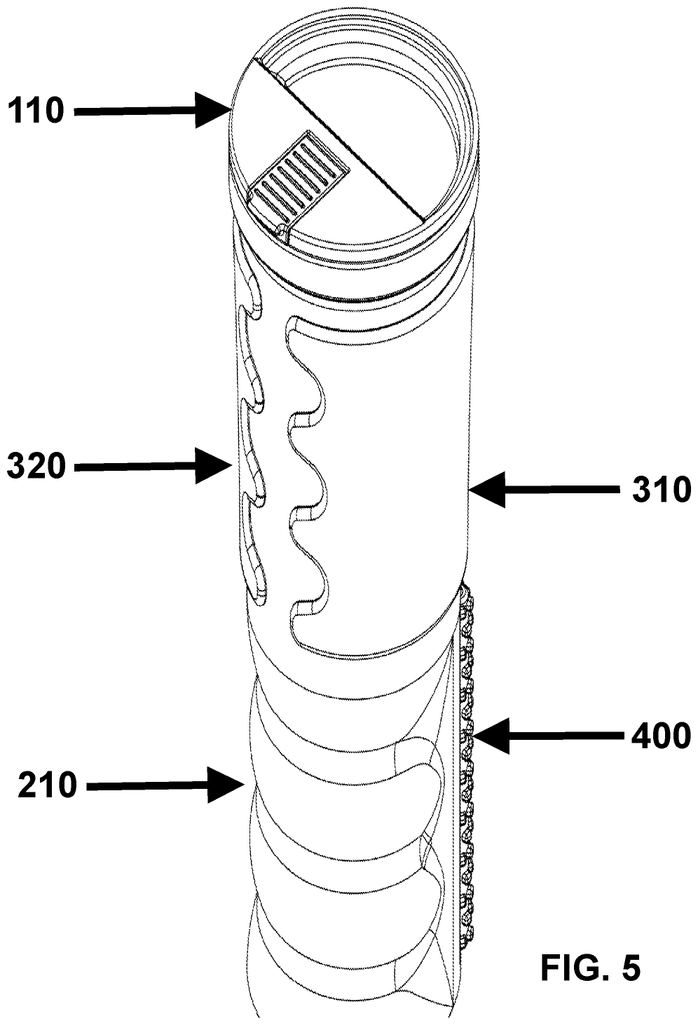

Referring to FIG. 5, the therapeutic bottle 500 in this construction shows the hard plastic vacuum seal lid 110. The rest of the construction depicts the separate cylindrical holder 200 with a hand grip that is shaped in an undulating pattern and includes the three divots 210 to provide a space for an individual to grip the bottle 500. This view also shows the foam material structure 310 and 320 that attaches around the top half of the cylindrical holder 200. This view also depicts a small portion of the hard plastic massage rollers 400.

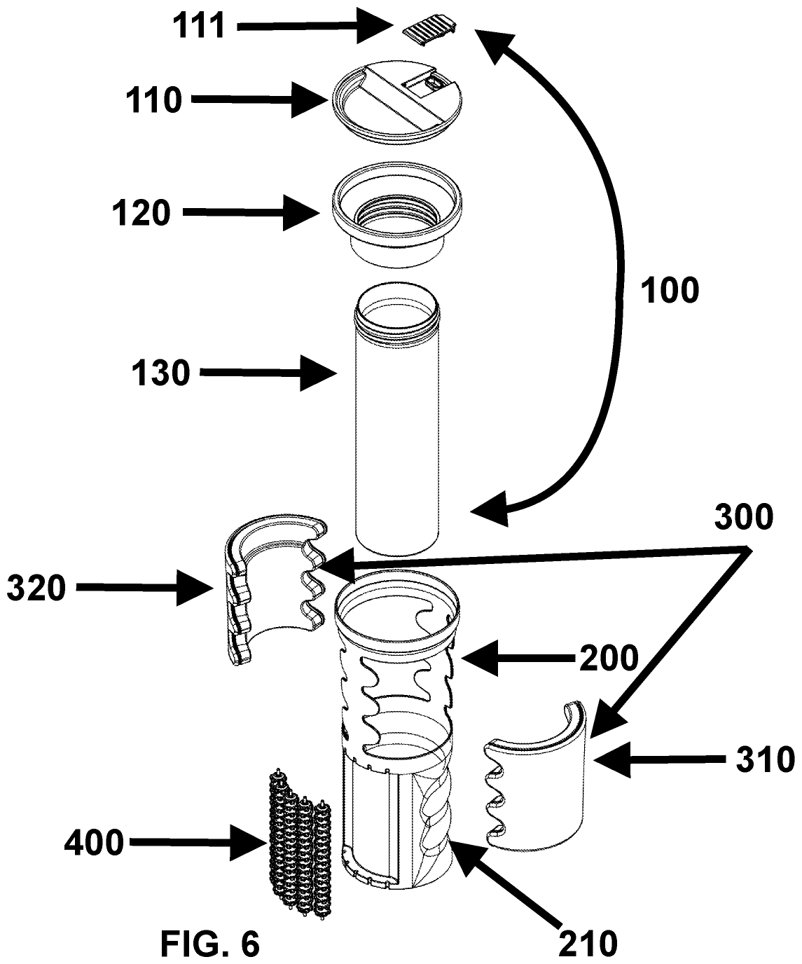

Referring to FIG. 6, depicts an exploded view of the therapeutic water bottle 500. There is provided the hollow vacuum seal vessel 100 in the shape of a cylinder. The hollow vacuum seal vessel 100 includes a vessel that serves the purpose of carrying liquids 130. The vessel 100 may a volume of 20 oz, for example. It is noted that vessel 100 can sealed with lid 110. The term “vacuum” is used with regard to the vessel 100 denotes “vacuum insulated” for temperature control of liquids therein. In other implementations, vessel 100 could be a double wall bottle with foam insulation sandwiched between the walls, or a single walled vessel. There is also the hard plastic lid 110. In between the hard-plastic lid 110 and the vessel that serves the purpose of carrying liquids there is an apparatus that connects the two 120. The apparatus that connects the two is made of plastic. Separate from this is the cylindrical holder 200. The cylindrical holder 200 may include three compartments that are configured to receive therein the two stress-releasing foam structures 310, 320 that sits at the top portion of the cylindrical holder 200 and the set of round plastic massage rollers 400 formed into a rectangular shape disposed on a bottom of one side of the cylindrical holder 200. The cylindrical holder 200 may include a hand grip shaped in an undulating pattern 210 and includes three separate divots to provide a space for an individual to grip the vessel and is affixed on the bottom of one side of the cylindrical holder that the set of round plastic massage rollers are not attached thereto.

In one or more constructions, the cylindrical holder 200 may include stress-releasing foam material structures 310 and 320 that are separated into two structures. In specific implementations, the stress-releasing foam structures may be made from a polymeric foam material, such as ethylvinyl acetate (EVA), polyurethane foam, and/or thermoplastic materials. In some implementations, the stress-releasing foam structures 310, 320 may be formed of a material having a hardness of Shore A 0-60 or a hardness of Shore 00 10-60. Preferably, stress-releasing foam structures 310, 320 may be formed of a material having a hardness of Shore A 20-30 or a hardness of Shore 00 20-25.

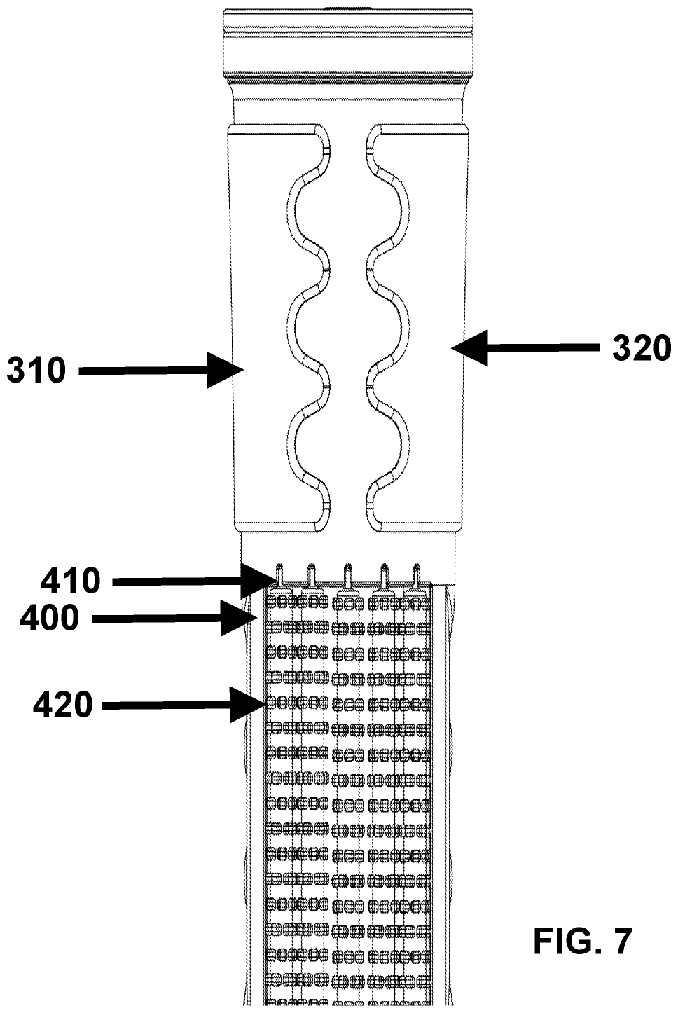

Referring to FIG. 7, in one or more constructions, the cylindrical holder 200 may include a set of round plastic massage rollers 400 comprised of five, long vertical cylindrical plastic massage rollers lined up in columns-like structures. Each of the rollers 400 has a center disposed rod 410 running through the center. Further, the exterior part of the rollers may have small, cube shaped protrusions 420 extending on the rollers used to improve the massaging effect of the user's hand and the rollers rotate when agitated. Nevertheless, in some constructions, the rollers may not include the protrusions 420; or some constructions, the rollers may have protrusions 420 (protrusion type-rollers), and other rollers may be free of protrusions (smooth surface-type roller). Thus, the set of rollers 400 provide differing message effects by having various combination of roller types. The rollers 400 provide a targeted massage tool for a user's hands, and arms to provide a myofascial release effect.

In one or more constructions, the rollers 400 are connected to the cylindrical holder 200 through the part of the cylindrical holder where the each of the round plastic massage rollers 400 can be urged to ‘click-in’ in a resilient locking connection. Thus, the rollers 400 may be removably mounted in the holder 200. In one or more implementations, the rollers 400 may be made from a polymeric material, such as ethylvinyl acetate (EVA), and/or thermoplastic materials. In some implementations, the rollers 400 may be formed of material having a hardness of Shore A 70-80 or a hardness of Shore D 50-60. Preferably, rollers 400 may be formed of material having a hardness of Shore A 80-90 or a hardness of Shore D 70-80.

In one or more constructions, a drinking bottle 500 includes features that allow someone to massage their hands or fidget with their hands which makes it convenient for an individual to carry around not only as one of their hydration sources, but also as a therapeutic tool that can be used throughout the day. In one or more constructions, the cylindrical holder 200 may be encircled by two separate a stress-releasing foam material sections 310 and 320 that are separated into two structures and attaches into two compartments around the top portion of the cylindrical holder and may leave small spaces between them on either side of the cylindrical holder. The distal ends of the stress-releasing foam structures are conformed in a semi-circle cutout pattern to accommodate a hand of a user.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A therapeutic bottle, comprising:
a cylindrical holder;
a cylindrical vessel that is retained in the cylindrical holder;
a stress-releasing foam structure that attaches around a top portion of the cylindrical holder; and
a set of massage rollers disposed below the stress-releasing foam structure on a side of the cylindrical holder.

2. The therapeutic bottle according to claim 1, wherein the cylindrical vessel further comprises a hard plastic lid.

3. The therapeutic bottle according to claim 2, wherein the lid further comprises of an openable tab that is fixated on a top lid wherein the top lid screws into an apparatus that connects the lid to the vessel that serves the purpose of carrying liquids.

4. The therapeutic bottle according to claim 1, wherein the cylindrical holder further comprises three compartments that various structures attach into and includes an affixed hand grip attached into one of the three compartments.

5. The therapeutic bottle according to claim 4, wherein the hand grip further comprises a wave pattern shape with three separate divots to provide a space for an individual to grip thereto; and the hand grip is affixed on the bottom portion of a side of the cylindrical holder.

6. The therapeutic bottle according to claim 1, wherein the stress-releasing foam structure further comprises two separate stress-releasing foam structures; and wherein the cylindrical holder further comprises three compartments so that the stress-releasing foam structures are attached into two of the three compartments being disposed around a top half of the cylindrical holder.

7. The therapeutic bottle according to claim 6, wherein distal ends of the stress-releasing foam structures are conformed in a wavy pattern and the stress-releasing foam structures further comprise a foam material having a hardness of Shore A 10-50.

8. The therapeutic bottle according to claim 1, wherein the set of massage rollers are provided on to a bottom compartment of the cylindrical holder.

9. The therapeutic bottle according to claim 8, wherein the set of massage rollers further comprises a hard plastic material.

10. The therapeutic bottle according to claim 9, wherein the set of massage rollers further comprises small, dull spikes used for massaging purposes and the massage rollers rotate when agitated.

11. The therapeutic bottle according to claim 8, wherein the set of massage rollers further comprises vertical massage rollers comprised of rods, running vertically through the center to connect them into the cylindrical holder.

12. The therapeutic bottle according to claim 8, wherein the set of massage rollers further comprises five, long vertical massage rollers lined up laterally.

13. A therapeutic bottle, comprising:
a cylindrical holder;
a cylindrical that is retained in the cylindrical holder; and
a set of massage rollers disposed on a side of the cylindrical holder.

14. The therapeutic bottle according to claim 13, wherein the cylindrical vessel further comprises a hard-plastic lid.

15. The therapeutic bottle according to claim 13, wherein the set of massage rollers are formed into a rectangular shape and attached on to the bottom compartment of the cylindrical holder.

16. The therapeutic bottle according to claim 15, wherein the set of massage rollers further comprises a material of hard plastic.

17. The therapeutic bottle according to claim 16, wherein the set of massage rollers further comprises small, dull spikes used for massaging purposes and the rollers rotate when agitated.

18. The therapeutic bottle according to claim 17, wherein the set of massage rollers further comprises vertical massage rollers including rods running vertically through the center thereof to connect the vertical massage rollers into the cylindrical holder.

19. The therapeutic bottle according to claim 13, wherein the set of massage rollers further comprises five, long vertical massage rollers lined up in columns.

20. The therapeutic bottle according to claim 13, further comprising a stress-releasing foam structure that attaches around a top portion of the cylindrical holder.
